(19) United States
(12) Patent Application Publication
(10) Pub. No.: US 2016/0198777 A1
(43) Pub. Date: Jul. 14, 2016

(54) Thermal Hoop Body Warmer

(71) Applicant: Michael Eugene Baker, Baltimore, MD (US)

(72) Inventor: Michael Eugene Baker, Baltimore, MD (US)

(21) Appl. No.: 14/991,283

(22) Filed: Jan. 8, 2016

Related U.S. Application Data
(60) Provisional application No. 62/101,000, filed on Jan. 8, 2015.

(51) Int. Cl. A41D 13/005; H05B 3/56

(52) U.S. Cl. CPC A41D 13/0051; H05B 3/56

(57) ABSTRACT

A heating apparatus contains a heating element, a clothing garment, a power source, and an intensity level controller. The heating element is positioned within the clothing garment. The clothing garment is worn by a user around the neck or any other appropriate position. The heating element emits heat through a body of the clothing garment. The user feels the emitted heat since the clothing garment is in contact with the user. The heating element is powered through the power source which is electrically connected to the heating element through the intensity level controller. The intensity level controller enables the user to control the heat emitted from the heating element such that the heating apparatus can be efficiently used in different conditions.

The current application claims a priority to the U.S. Provisional Patent application Ser. No. 62/101,000 filed on Jan. 08, 2015.

### FIELD OF THE INVENTION

The present invention relates generally to body warmers. More specifically, the present invention is a device that can be worn on a bodily figure for body warming purposes.

### BACKGROUND OF THE INVENTION

Body warmers are used to maintain the human body temperature when the atmospheric temperature drops. More specifically, body warmers are used to avoid hypothermia and other related situations that can occur due to excessive exposure to cold air or water. Body warmers can vary in type and size. As an example, body warmers can appear as multiple layers of clothing or as thermal clothing. On the other hand, body warmers can also be found as small portable packets which can be used along with regular clothing. Even though the existing body warmers fulfill the task of maintaining human body temperature to a certain extent, they have certain disadvantages too.

A major disadvantage of existing body warmers is the heat emitting duration. When considering a body warmer which is used along with a clothing garment, the heat emitted from the body warmer lessens after a certain time period. Therefore, the intended purpose of the body warmer is not completely fulfilled. The limited duration is especially unfavorable to individuals such as construction workers and athletes who remain outdoors for extended time periods. Moreover, since most existing body warmers are not reusable, the need to continuously purchase body warmers can be financially disadvantageous.

Another issue with existing body warmers is the need to utilize specific types of clothing along with the body warmer. If the body warmer is used for warming the hands of the user, the body warmer can be used along with the gloves. However, if the body warmer is intended to be used for warming a neck area of the user, a scarf or any other garment that is in contact with the neck area needs to have designated compartments to hold the body warmers. Since most garments are not equipped with the ability to accommodate body warmers, the use of the body warmers are fairly limited. Additionally, when the body warmers are used with different clothing garments, the aesthetically pleasing appearance of the garment can also be hindered.

Most body warmers do not allow the user to control the intensity of the emitted heat. Therefore, the user has to constantly reposition or adjust the body warmer in order to obtain the preferred heat levels. Repositioning and adjusting the body warmer can be stressful especially over an extended period of time.

The objective of the present invention is to address the aforementioned issues. In particular, the present invention introduces an apparatus that can be worn around the body for temperature controlling purposes. By utilizing the present invention, the user is guaranteed to maintain a preferred temperature with the added capability of controlling the heat level. In contrast to existing body warmers the heating apparatus of the present invention can be reused.

### BRIEF DESCRIPTION OF THE DRAWINGS

FIG. 1 is an illustration of the present invention being worn around the neck of a user.

FIG. 2 is another illustration of the present invention being worn around the neck of the user.

FIG. 3 is another illustration of the present invention, wherein the clothing garment contains a holding compartment.

FIG. 4A is another illustration of the present invention, wherein the attachment mechanism is represented.

FIG. 4B is a cross sectional view of the first end and the second end being attached through the attachment mechanism.

FIG. 5 is an illustration of the electrical connection between the power source, the intensity level controller, and the heating element.

FIG. 6 is an illustration of the electrical connection between the power source, the intensity level controller, the connector, and the heating element.

### DETAIL DESCRIPTIONS OF THE INVENTION

All illustrations of the drawings are for the purpose of describing selected versions of the present invention and are not intended to limit the scope of the present invention.

The present invention introduces a heating apparatus that can be worn by a user. The effective design allows the user to utilize the present invention in multiple configurations. Furthermore, the present invention gives the user the ability to control the amount of heat emitted from the apparatus which is nonexistent in currently available heating apparatuses.

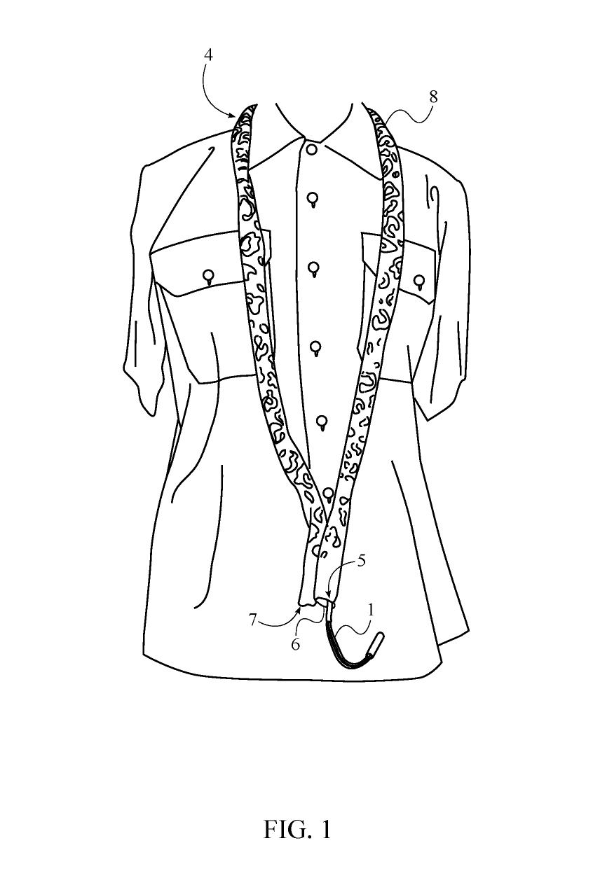

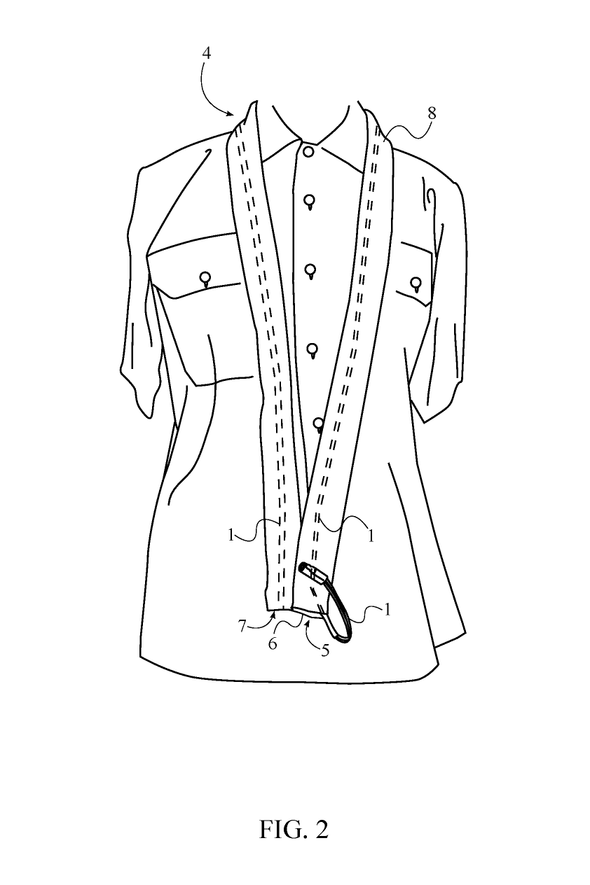

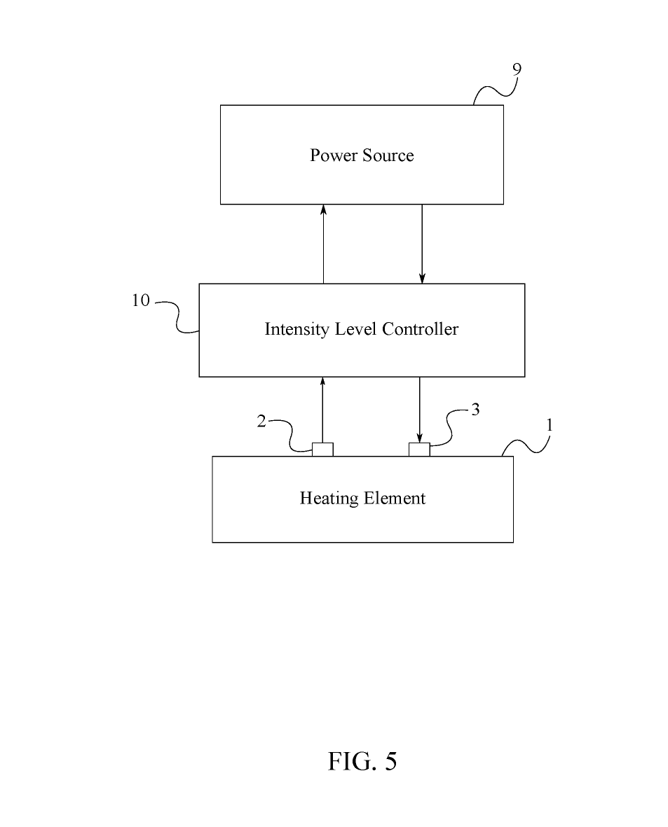

As illustrated in FIG. 1, FIG. 2, and FIG. 5, the heating apparatus introduced in the present invention comprises a heating element 1, a clothing garment 4, a power source 9, and an intensity level controller 10. The heating element 1 is used to generate the heat required to maintain the body temperature. In the preferred embodiment of the present invention, the heating element 1 is a resistance wire. Therefore, the emitted heat depends on the current that is passed through the resistance wire. However, the heating element 1 can change in different embodiments of the present invention. As an example, the heating element can be a plurality of hand warmers or other comparable heating source in another embodiment of the present invention. The clothing garment 4 allows the user to wear the present invention as preferred. In the preferred embodiment of the present invention, the clothing garment 4 is designed such that the present invention can be worn around the neck of the user similar to a scarf. The clothing garment 4 comprises a first end 5 and a second end 7. The user holds the clothing garment 4 by the first end 5 and the second end 7 and wears the clothing garment 4 such that a body 8 of the clothing garment 4 is in contact with the user. The body 8 extends from the first end 5 to the second end 7. Therefore, the body 8 can be adjusted or repositioned by holding the first end 5 and the second end 7. The heating element 1 is sleeved within the body 8 from the first end 5 to the second end 7. As a result, the position of the heating element 1 can also be adjusted by holding the first end 5 and the second end 7. When the present invention is being used, the heat emitted by the heating element 1 reaches the user through the body 8 of the clothing garment 4. Therefore, the clothing garment 4 is made of a heat transferring material of minimum thickness.

The power source 9 of the present invention provides power to the heating element 1. The power source 9 can vary in different embodiments of the present invention. In the preferred embodiment of the present invention the power source 9 is a battery. As previously mentioned, the present invention allows the user to control the heat levels through the intensity level controller 10. The heat emitted from the heating element 1 has a proportional relationship to the current passing through the resistance wire. The intensity level controller 10 manages the current that is passed through the resistance wire such that the heat emitted from the heating element 1 can be controlled according to user preference. In order to do so, the intensity level controller 10 is electrically connected to the heating element 1. Thus, by controlling the current passing through the resistance wire, the intensity level controller 10 manages the heat emitted by the heating element 1. In the process of completing the heating circuit, the heating element 1 is electrically connected to the power source 9 though the intensity level controller 10 as seen in FIG. 5.

As previously mentioned, the heating element 1 is sleeved by the clothing garment 4. In order to provide an access point to the heating element 1, the first end 5 comprises an opening 6. A first terminal 2 and a second terminal 3 of the heating element 1 are positioned about the opening 6 opposite the body 8. The positioning of the first terminal 2 and the second terminal 3 allows the user to conveniently access the heating element 1. The first terminal 2 and the second terminal 3 are used to supply power to the heating element 1. Therefore, the first terminal 2 and the second terminal 3 are electrically connected to the power source 9 through the intensity level controller 10.

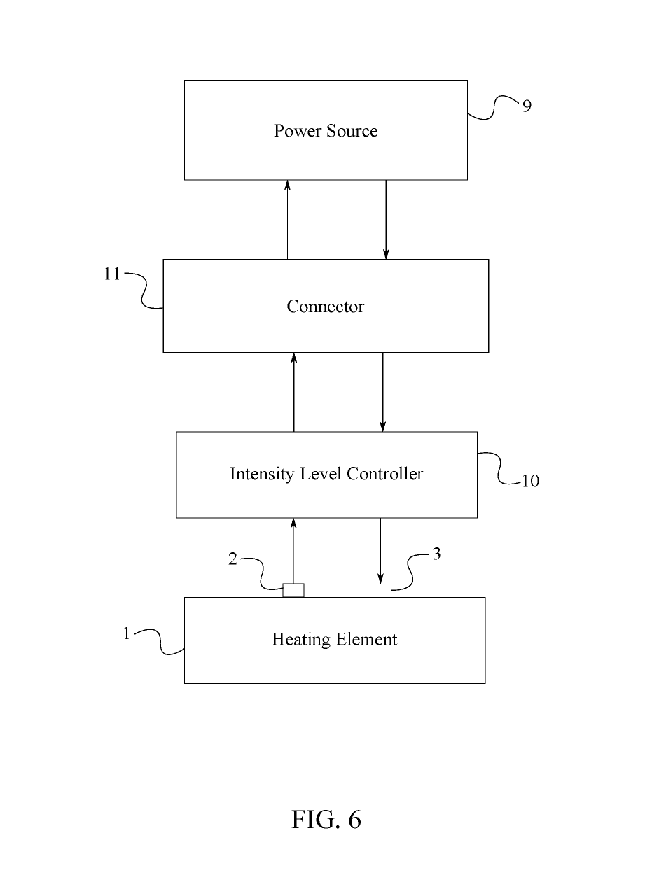

In order to provide user convenience, the present invention further comprises a connector 11. As seen in FIG. 6, the connecter allows the user to control the power supply as preferred. In order to do so, the heating element 1 is electrically connected to the connecter 11 with the first terminal 2 and the second terminal 3 through the intensity level controller 10. Moreover, the connecter 11 is electrically connected to the power source 9 as required. In the preferred embodiment of the present invention, the connecter 11 is electrically connected to the battery. The electrical connections between the heating element 1, the connector 11, and the power source 9 allows the user to interchange the heating element 1 or the power source 9 as necessary. Since the first terminal 2 and the second terminal 3 are positioned about the opening 6, the connector 11 is also positioned adjacent the opening 6.

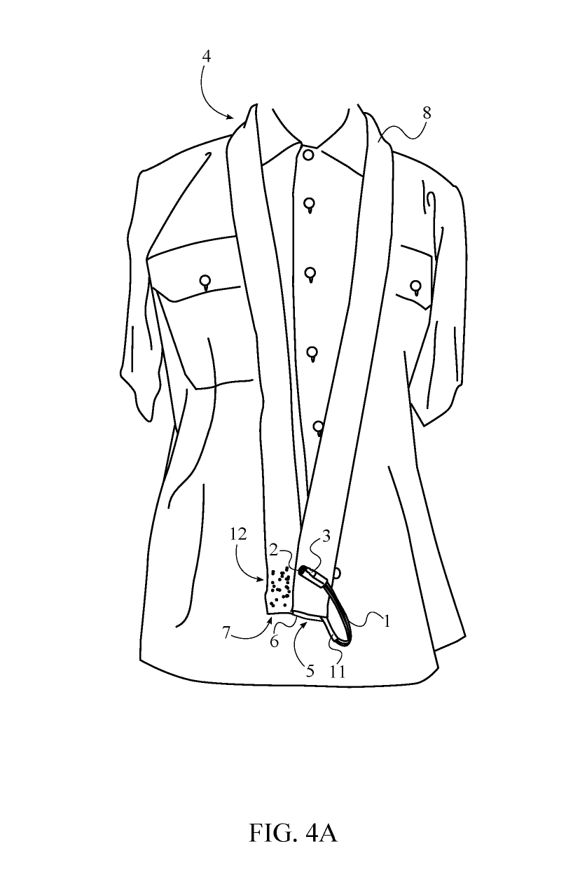

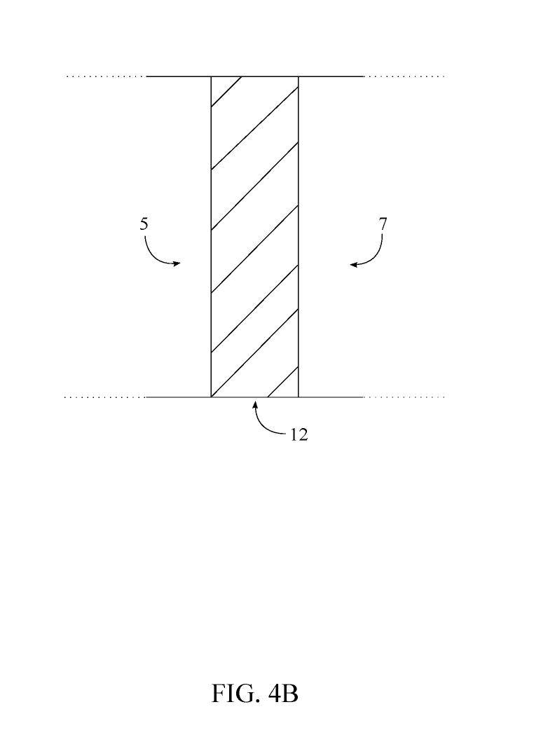

As previously discussed, the present invention is worn by the user. In order to secure the present invention against the body 8 of the user, the present invention comprises an attachment mechanism 12. The first end 5 and the second end 7 are detachably attached through the attachment mechanism 12 such that the user can position the clothing garment 4 in a preferred configuration. As seen in FIG. 4A and FIG. 4B, a plurality of hook and loop fasteners is utilized as the attachment mechanism 12 in the preferred embodiment of the present invention. However, different attachment mechanisms such as a zipper can be utilized in other embodiments of the present invention.

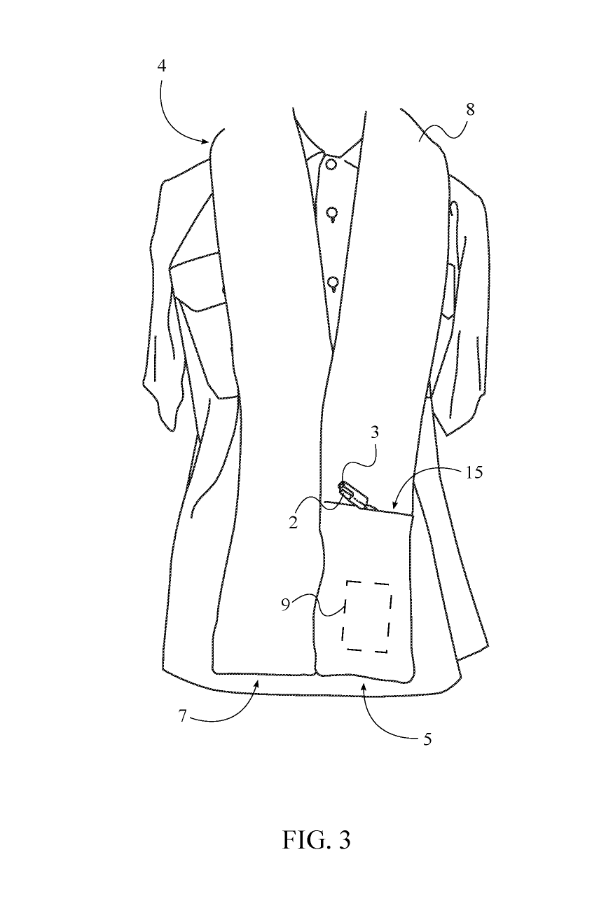

In the preferred embodiment of the present invention, the power source 9 is positioned externally. As an example, if the clothing garment 4 is worn around the neck of the user, the power source 9 can be placed externally in a pocket of the clothing of the user. However, in another embodiment of the present invention, the power source 9 can be positioned along with the clothing garment 4 through a holding compartment 15 as in FIG. 3. In doing so, the holding compartment 15 is embedded onto the body 8 and the power source 9 is positioned in the holding compartment 15. Positioning the power source 9 within the holding compartment 15 increases the number of configurations of the present invention. Moreover, the need to position the power source 9 in an appropriate position is eliminated with the use of the holding compartment 15.

When utilizing the present invention, the following procedure can be followed. Initially, the present invention is positioned around the body of the user in an appropriate manner. The first end 5 and the second end 7 are utilized in positioning the clothing garment 4 as required. By positioning the clothing garment 4, the user also simultaneously positions the heating element 1 which is sleeved by the body 8. When the clothing garment 4 and the heating element 1 are positioned as preferred, the power source 9 is positioned in a pocket of the user. If the holding compartment 15 is available, the power source 9 is positioned in the holding compartment 15. Next, by handling the intensity level controller 10 the user adjusts the heat emitted by the heating element 1. If the need occurs to detach the heating element 1 from the power source 9, the user detaches the first terminal 2 and the second terminal 3 from the connector 11. The connector 11 can also be used to replace the power source 9. In doing so, the power source 9 is disconnected from the connecter 11 such that the overall power supply is cut off.

Although the invention has been explained in relation to its preferred embodiment, it is to be understood that many other possible modifications and variations can be made without departing from the spirit and scope of the invention as hereinafter claimed.

What is claimed is:

1. A heating apparatus to be worn by an individual comprises:
a heating element;
a clothing garment;
a power source;
an intensity level controller;
the clothing garment comprises a first end, a body, and a second end;
the body extending from the first end to the second end;
the heating element being sleeved within the body from the first end to the second end;
the intensity level controller being electrically connected to the heating element; and
the heating element being electrically connected to the power source through the intensity level controller.

2. The heating apparatus to be worn by an individual as claimed in claim 1 comprises:
the first end comprises an opening;
the heating element comprises a first terminal and a second terminal;
the first terminal and the second terminal being positioned about the opening opposite the body; and
the first terminal and the second terminal being electrically connected to the power source through the intensity level controller.

3. The heating apparatus to be worn by an individual as claimed in claim 2 comprises:
a connecter;
the heating element being electrically connected to the connecter with the first terminal and the second terminal;
the connecter being electrically connected to the power source; and
the connecter being positioned adjacent the opening of the first end.

4. The heating apparatus to be worn by an individual as claimed in claim 1 comprises:
an attachment mechanism; and
the first end and the second end being detachably attached through the attachment mechanism.

5. The heating apparatus to be worn by an individual as claimed in claim 4, wherein the attachment mechanism is a plurality of hook and loop fasteners.

6. The heating apparatus to be worn by an individual as claimed in claim 1, wherein the heating element is a resistance wire.

7. The heating apparatus to be worn by an individual as claimed in claim 1, wherein the power source is a battery.

8. The heating apparatus to be worn by an individual as claimed in claim 1 comprises:
a holding compartment; and
the holding compartment being embedded onto the body;
the power source being positioned in the holding compartment.
